(19) United States
(12) Patent Application Publication
(10) Pub. No.: US 2026/0038161 A1
(43) Pub. Date: Feb. 5, 2026

(54) LEARNING SYSTEM, LEARNING METHOD, INFERENCE SYSTEM, INFERENCE METHOD, AND STORAGE MEDIUM

(71) Applicant: CANON KABUSHIKI KAISHA, Tokyo (JP)

(72) Inventor: HIDEAKI MIZOBE, Kanagawa (JP)

(21) Appl. No.: 19/270,306

(22) Filed: Jul. 15, 2025

(30) Foreign Application Priority Data
Jul. 31, 2024 (JP) 2024-124475

(51) Int. Cl. G06T 11/00; G06T 7/00

(52) U.S. Cl. CPC G06T 11/00; G06T 7/0002; G06T 2207/20081; G06T 2207/30101; G06T 2207/30168; G06T 2210/41

(57) ABSTRACT

A learning system, for performing training of an image generation model configured to output a generated image having one or more bright spot regions and corresponding to an input image, acquires training data including an input image and a correct answer image having one or more bright spot regions and corresponding to the input image; inputs the input image to the image generation model to acquire a generated image; acquires, based on the correct answer image, a first bright spot image including at least one bright spot region included in the one or more bright spot regions; acquires, based on the generated image obtained by inputting the input image to the image generation model, a second bright spot image corresponding to the first bright spot image; and updates the image generation model based on an error between the first bright spot image and the second bright spot image.

### BACKGROUND

### Field of the Technology

Aspects of the present disclosure generally relate to a learning system, a learning method, an inference system, an inference method, and a storage medium.

### Description of the Related Art

In recent deep learning techniques, a method of, while maintaining structural features of an image in a predetermined domain, generating an image imitating an image in a different domain has been proposed. For example, in Non-Patent Literature 1 mentioned below, a method of receiving, as an input, a retinal fundus image not using a contrast agent and outputting a generated image resembling a fluorescein fluorescence fundus angiography (FA) examination image has been proposed. Moreover, in Patent Literature 1 mentioned below, a method of receiving, as an input, a fundus examination image and outputting an image which reproduces an anomalous region generated based on a contrast examination image has been proposed.
Non-Patent Literature 1: Alireza Tavakkoli, Sharif Amit Kamran, Khondker Fariha Hossain, Stewart Lee Zuckerbrod, “A novel deep learning conditional generative adversarial network for producing angiography images from retinal fundus photographs.”, Sci Rep 10, 21580(2020), <https://doi.org/10.1038/s41598-020-78696-2> (published on Dec. 9, 2020)
Patent Literature 1: Japanese Patent Application Laid-Open No. 2022-180466

However, in the method described in Non-Patent Literature 1 or Patent Literature 1, there may be a case where it is impossible to visualize or depict, in a plausible manner, appearances of some regions, such as, especially, an appearance of a region relatively small with respect to the entire image or an appearance of an anomalous region.

### SUMMARY

According to an aspect of the present disclosure, a learning system, for performing training of an image generation model configured to output a generated image having one or more bright spot regions and corresponding to an input image, includes at least one processor and at least one memory that is in communication with the at least one processor. The at least one memory stores instructions for causing the at least one processor and the at least one memory to acquire training data including an input image and a correct answer image having one or more bright spot regions, wherein the correct answer image corresponds to the input image; input the input image to the image generation model and acquire a generated image; acquire, based on the correct answer image, a first bright spot image including at least one bright spot region included in the one or more bright spot regions; acquire, based on the generated image obtained by inputting the input image to the image generation model, a second bright spot image corresponding to the first bright spot image; and update the image generation model based on an error between the first bright spot image and the second bright spot image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a learning system according to a first embodiment.

FIG. 2 is a diagram illustrating an example of training data according to the first embodiment.

FIG. 3 is a diagram illustrating types of regions according to the first embodiment.

FIG. 4 is a diagram illustrating examples of leakage regions according to the first embodiment.

FIG. 5 is a diagram illustrating an example of bright spot region information (coordinates of a rectangular region) according to the first embodiment.

FIG. 6 is a diagram illustrating an example of a configuration of a network model according to the first embodiment.

FIG. 7 is a diagram illustrating examples of types of losses according to the first embodiment.

FIG. 8 is a flowchart related to a learning process for an image generation model according to the first embodiment.

FIG. 9 is a diagram illustrating examples of settings of a foreground and a background according to a modification example 1 of the first embodiment.

FIG. 10 is a diagram illustrating a configuration of a learning system according to a second embodiment.

FIG. 11 is a flowchart related to a learning process for an image generation model according to the second embodiment.

FIG. 12 is a diagram illustrating a configuration of an inference system according to a third embodiment.

FIG. 13 is a flowchart related to an inference process for an image generation model according to the third embodiment.

### DESCRIPTION OF THE EMBODIMENTS

Various embodiments, features, and aspects of the disclosure will be described in detail below with reference to the drawings. Furthermore, the following embodiments should not be construed to limit the claims. While a plurality of features is described in the embodiments, not all of the plurality of features are necessarily essential for every embodiment, and, moreover, some or all of the plurality of features can be optionally combined. Additionally, in the drawings, the same or similar constituent elements are assigned the respective same reference characters, and any duplicated description thereof is omitted.

Furthermore, while, for the sake of clarity, in the description and drawings, a two-dimensional image is mainly described as a target to be handled, in the following embodiments, not only a two-dimensional image but also a three-dimensional image can be handled.

Moreover, in medical images to be handled in the description of embodiments, usually a blood vessel or a site exhibiting a contrast imaging effect is displayed brightly compared with the other sites, but, conversely, may be displayed darkly depending on the imaging apparatuses, the setting of an imaging apparatus, or a display device. However, in the following description, for the sake of clarity, a blood vessel or a site exhibiting a contrast imaging effect is assumed to be recorded in such a way as to be displayed brightly on an image. Specifically, a bright pixel is assumed to be high in pixel value and a dark pixel is assumed to be low in pixel value.

Moreover, the term “bright spot region” to be handled in the description of embodiments is assumed to represent a connected region which is brighter than the surrounding area (thus, having pixel values larger than or equal to predetermined pixel values compared with the surrounding pixel values) and is relatively small with respect to the entire image (less than or equal to a predetermined maximum area or maximum volume).

Furthermore, for the sake of clarity, the term “bright spot region” in the description of embodiments refers to a connected region in which the appearance of a subject has been visualized or depicted, and, unless otherwise mentioned, is not a connected region in which, for example, noises caused by conditions of, for example, an imaging apparatus or an image processing operation have been visualized or depicted.

Moreover, processing for discriminating, on an image, a connected region in which the “bright spot region” has been visualized or depicted from a visualized or depicted region resembling what is called a bright spot noise can be performed. Specifically, the “bright spot region” can be assumed to be not only a connected region with an area or volume less than or equal to a predetermined maximum area or maximum volume but also a connected region with an area or volume greater than or equal to a predetermined minimum area or minimum volume, i.e., a connected region with an area or volume within a predetermined range thereof.

One issue that some of the disclosed embodiments try to solve is to improve a visualizing or depicting performance for the appearance of a generated image. For example, such an issue may be to improve a visualizing or depicting performance for a region of leakage of a contrast agent in a generated image for a medical image.

However, the issues which the disclosed embodiments try to solve are not limited to the above-mentioned issue. Issues corresponding to respective advantageous effects exhibited by various constituent elements illustrated in the embodiments described below can be positioned as the other issues.

### First Embodiment

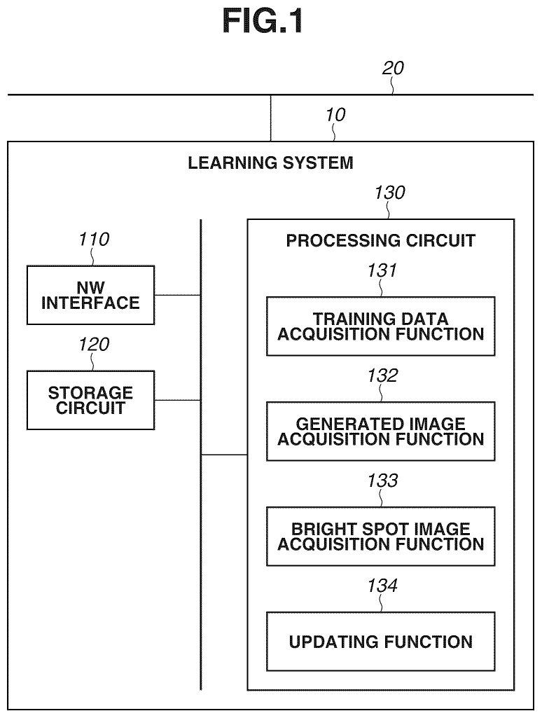

An example of a configuration of a learning system 10 according to a first embodiment is described with reference to FIG. 1.

Furthermore, the configuration illustrated in FIG. 1 is merely an example, and the number of devices or circuits can be optionally changed. Moreover, a device which is not illustrated in FIG. 1 can be connected to a network 20.

For example, the learning system 10 includes a network (NW) interface 110, a storage circuit 120, and a processing circuit 130.

The NW interface 110 is connected to the processing circuit 130 and controls transmission and communication of various pieces of data which are performed between the respective devices interconnected via the network 20. For example, the NW interface 110 may be implemented with, for example, a network card, a network adapter, or a network interface controller (NIC).

The storage circuit 120 is connected to the processing circuit 130 and stores various pieces of data. Moreover, the storage circuit 120 stores various programs, which the processing circuit 130 can read out and execute to implement various functions. For example, the storage circuit 120 may be implemented with a semiconductor memory element, such as a random access memory (RAM) or a flash memory, or another storage medium, such as a hard disk or an optical disc.

The processing circuit 130 controls the entire operation of the learning system 10. The processing circuit 130 includes, for example, a training data acquisition function 131, a generated image acquisition function 132, a bright spot image acquisition function 133, and an updating function 134. In the first embodiment, the respective processing functions serving as constituent elements of the processing circuit 130 are stored in the storage circuit 120 in the form of programs which are executable by a computer. The processing circuit 130 is a processor which implements functions corresponding to the respective programs by reading out the programs from the storage circuit 120 and executing the read-out programs. In other words, the processing circuit 130 in the state of having read out the programs can be said to include various processing functions shown in the processing circuit 130 illustrated in FIG. 1.

Furthermore, in the description of FIG. 1, the processing circuit 130 is assumed to be a single processor for implementing the respective functions.

The respective functions are, for example, the training data acquisition function 131, the generated image acquisition function 132, the bright spot image acquisition function 133, and the updating function 134. However, the entity of performing processing does not need to be a single processor; a plurality of independent processors can be configured to constitute the processing circuit 130 in combination and the respective processors can be configured to implement the processing functions by executing the programs. Moreover, while, in the description of FIG. 1, a single storage circuit such as the storage circuit 120 stores the programs corresponding to the respective processing functions, a plurality of storage circuits can be dispersedly arranged and the processing circuit 130 can be configured to read out a corresponding program from an individual storage circuit.

The term “processor” mentioned in the above description means, for example, a circuit such as a central processing unit (CPU), a graphics processing unit (GPU), an application specific integrated circuit (ASIC), a programmable logic device (for example, a simple programmable logic device (SPLD)), a complex programmable logic device (CPLD), or a field programmable gate array (FPGA). The processor implements the respective processing functions by reading out programs stored in the storage circuit 120 and executing the programs. Furthermore, a configuration in which, instead of programs being stored in the storage circuit 120, the programs are directly incorporated into circuits included in the processor can be employed. In this case, the processor implements the respective processing functions by reading out programs incorporated into the circuits and executing the programs.

The storage circuit 120 has a data set stored therein. Alternatively, instead of storing the data set in the storage circuit 120, the learning system 10 can be configured to acquire the data set from a system (not illustrated) via the network 20 and use the acquired data set.

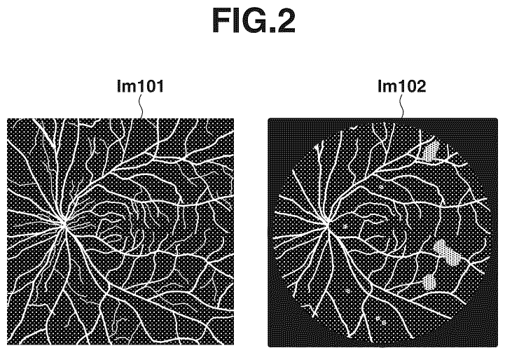

The data set is configured with one or more pairs of training data groups, with a pair including an input image and a correct answer image being set as a pair of pieces of training data. The input image in the first embodiment is an optical coherence tomography (OCT) angiography (OCTA) image acquired by an OCT apparatus, such as an image Im101 illustrated in FIG. 2. Moreover, the correct answer image is a fluorescein fluorescence fundus angiography examination image (FA image), such as an FA image Im102 illustrated in FIG. 2, acquired by imaging the same subject as that for an OCTA image serving as an input image corresponding thereto as a pair. Furthermore, the FA image is assumed to be position-adjusted (modified) in anatomical structure with respect to an OCTA image serving as an input image corresponding thereto as a pair. Moreover, the correct answer image can be a segment image representing a region of leakage of a contrast agent such as that visualized or depicted in an FA image. Moreover, the contrast imaging time for an FA image included in the data set being limited to a predetermined range of, for example, 60 seconds to 70 seconds causes a variation in modes of contrast imaging effects for a correct answer image group to decrease and, as a result, stabilizes a contrast imaging effect which is expressed in a generated image, thus being favorable. Moreover, such position adjustment is assumed to be implemented by an FA image being modified by, for example, manual image processing or image registration processing in such a manner that, for example, a vascular structure in an OCTA image and a vascular structure in an FA image almost coincide with each other.

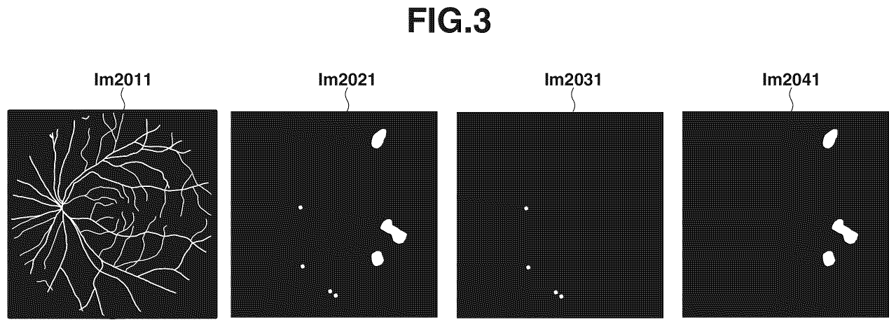

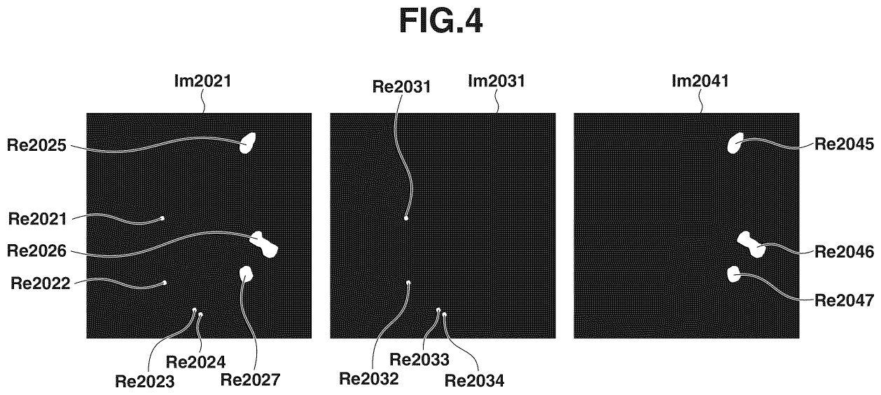

Here, the terms and derived data related to an FA image, which are used for the description of embodiments including the first embodiment are described with reference to FIG. 3 and FIG. 4.

A region in which blood vessels are visualized or depicted in an FA image is referred to as a “blood vessel region”. The blood vessel region can be, for example, manually determined by a human with respect to an FA image or can be determined by image segmentation processing. Moreover, an image obtained by performing image segmentation with the blood vessel region set as a foreground and a region other than the blood vessel region set as a background is referred to as a “blood vessel region image”. For example, a blood vessel region image corresponding to the FA image Im102 is an image such as an image Im2011 illustrated in FIG. 3. Furthermore, there is also a case where, on an FA image, a blood vessel region and a region of leakage of a contrast agent (a contrast agent leakage region) overlap each other and the blood vessel region is hard to recognize. However, an almost correct blood vessel region can be determined by performing estimation from running of blood vessels in another region, by performing estimation while referring to an image of the same subject acquired by a fundus camera or an optical coherence tomography (OCT) apparatus, or by using a known blood vessel extraction algorithm.

A region which is brightly visualized or depicted due to a contrast agent leaking without following running of blood vessels in an FA image is referred to as a “leakage region”. The leakage region can be, for example, manually determined by a human with respect to an FA image or can be determined by image segmentation processing by performing image processing mainly including removing a blood vessel region in an FA image.

Moreover, an image obtained by performing image segmentation with the leakage region set as a foreground and a region other than the leakage region set as a background is referred to as a “leakage region image”. For example, a leakage region image corresponding to the FA image Im102 is an image such as an image Im2021 illustrated in FIG. 3, in which seven independent leakage regions, thus serving as connected regions (regions Re2021 to Re2027 illustrated in FIG. 4), can be confirmed.

From among leakage regions in an FA image, a region for a bright spot which is derived from the existence of, for example, a capillary aneurysm and is brightly visualized or depicted in a locally small fashion is referred to as a “bright spot region”.

The bright spot region can be, for example, manually determined by a human with respect to an FA image or can be determined by image segmentation processing or by selecting a region having an area (in the case of targeting a three-dimensional image, a volume) within a predetermined range from the leakage regions.

Moreover, an image obtained by performing image segmentation with the bright spot region set as a foreground and a region other than the bright spot region set as a background is referred to as a “bright spot region image”. For example, a bright spot region image corresponding to the FA image Im102 is an image such as an image Im2031 illustrated in FIG. 3, in which four independent bright spot regions, thus serving as connected regions (regions Re2031 to Re2034 illustrated in FIG. 4), can be confirmed.

For the sake of discriminable explanation, from among leakage regions in an FA image, a region other than a bright spot region may be, in some cases, referred to as a “large leakage region”. The large leakage region, as with the bright spot region, can be, for example, manually determined by a human with respect to an FA image or can be determined by image segmentation processing or by selecting a region having an area within a predetermined range from the leakage regions.

Moreover, an image obtained by performing image segmentation with the large leakage region set as a foreground and a region other than the large leakage region set as a background is referred to as a “large leakage region image”. For example, a large leakage region image corresponding to the FA image Im102 is an image such as an image Im2041 illustrated in FIG. 3, in which three independent large leakage regions, thus serving as connected regions (regions Re2045 to Re2047 illustrated in FIG. 4), can be confirmed.

The bright spot region is at least a partial region of a connected region having a pixel value greater than or equal to a predetermined value or a pixel value less than or equal to a predetermined value in an image and having a size within a predetermined range. Moreover, the acquisition of the bright spot region can be implemented by an acquisition function for a bright spot image (a bright spot image acquisition function) described below. With regard to the bright spot region, a region smaller than a predetermined value (area) included in a leakage region image derived from a capillary aneurysm is acquired as a bright spot region.

The data set according to the first embodiment further includes bright spot region information which is information concerning coordinates of a rectangular region containing, in the form of being associated with respective FA images included in the data set, bright spot region groups of the respective FA images. The rectangular region corresponding to the bright spot region information (coordinates of the rectangular region) contains at least one bright spot region. The rectangular region is set in consideration of an area ratio or volume ratio obtained when a bright spot region is set as a foreground and a region other than the bright spot region is set as a background. Specifically, the coordinates of the rectangular region can be adjusted in such a manner that the area ratio (in the case of targeting a three-dimensional image, the volume ratio) between the foreground and the background becomes approximately 1:1.

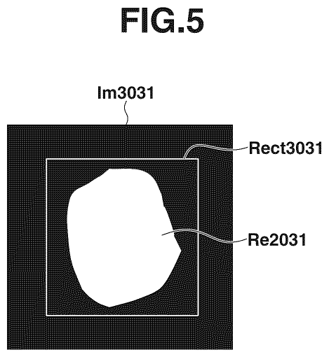

Furthermore, in a case where a region bright to the same degree or more as a bright spot region such as a blood vessel region is included in the background, the coordinates of a rectangular region can be adjusted with a region excluding such bright region set as a new background. A specific example is described with use of a partial bright spot region image Im3031 illustrated in FIG. 5, which is obtained by magnifying the vicinity of a region Re2031 included in the bright spot region image Im2031 illustrated in FIG. 4.

The partial bright spot region image Im3031 includes a bright spot region Re2031, and a rectangular region Rect3031 is set in such a way as to contain the bright spot region Re2031. Inside the rectangular region Rect3031, a white portion serving as the bright spot region Re2031 is a foreground, the other black portion is a background, and the coordinates of the rectangular region Rect3031 are adjusted in such a manner that the area ratio between the foreground and the background becomes approximately 1:1.

Furthermore, while, with regard to the coordinates of a rectangular region to be adjusted in such a manner that the area ratio between the foreground and the background becomes approximately 1:1, there can be a number of candidates, it is favorable to automatically determine the coordinates of a rectangular region according to a predetermined rule for the sake of, for example, reproducibility. For example, in a condition in which the center of mass of the foreground and the center of mass of the rectangular region coincide with each other and the width and height of the rectangle coincide with each, the coordinates of a rectangular region in a state in which the area ratio between the foreground and the background comes closest to 1:1 can be employed.

Moreover, for example, while a rectangular region is magnified by moving the leftmost coordinate, the uppermost coordinate, the rightmost coordinate, and the lowermost coordinate for sequentially identifying the rectangular region from the state of a minimum rectangular region containing a bright spot region, the coordinates of a rectangular region in a state in which the area ratio between the foreground and the background is approximately 1:1 can be employed.

Furthermore, the above-mentioned processing can be performed as processing for generating bright spot region information from training data which the bright spot image acquisition function 133 of the learning system 10 has acquired.

Thus, the bright spot image acquisition function 133 included in the learning system 10 generates bright spot region information based on the ratio between the foreground and the background. Specifically, the bright spot image acquisition function 133 can set a rectangular region in an FA image in such a manner that the area ratio between the foreground and the background becomes 1:1. In other words, the bright spot image acquisition function 133 is characterized by determining the sizes of a first bright spot image and a second bright spot image based on a relationship between the size of a bright spot region visualized or depicted in the first bright spot image and the size of a background region which is at least a partial region other than the bright spot region in the first bright spot image.

Furthermore, in a case where a rectangular region protrudes from an image space in response to a given coordinate for identifying the rectangular region being moved, the bright spot image acquisition function 133 can move the other coordinates in such a way as to prevent the rectangular region from protruding or can stop moving the given coordinate.

Furthermore, while, in the first embodiment, with regard to the learning system 10, the execution content of learning processing using a rectangular region as the shape of a region of interest including a bright spot region is described, if there is no contradiction, the region of interest can be of another shape such as an elliptical region or a triangular region. In this case, the bright spot region information can be configured to include coordinates representing the shape of the region of interest.

Next, the functional configuration of the learning system 10 is described in detail with reference to FIG. 1. Here, the learning system 10 is a system for performing training of an image generation model which outputs a generated image having one or more bright spot regions, which corresponds to an input image.

The learning system 10 according to the first embodiment is a learning system for performing training of an image generation model which outputs a generated image having one or more bright spot regions, which corresponds to an input image. The learning system 10 includes the training data acquisition function 131, which acquires training data configured to include an input image and a correct answer image having one or more bright spot regions corresponding to the input image. Moreover, the learning system 10 includes the generated image acquisition function 132, which inputs the input image to the image generation model and thus acquires a generated image. Additionally, the learning system 10 includes the bright spot image acquisition function 133, which acquires a first bright spot image including a bright spot region based on the correct answer image and acquires a second bright spot image corresponding to the first bright spot image based on a generated image obtained by inputting the input image to the image generation model. Additionally, the learning system 10 further includes the updating function 134, which updates the image generation model based on an error between the first bright spot image and the second bright spot image.

With the above-mentioned respective functional processes being performed with use of training data, the image generation model, which outputs a generated image having one or more bright spot regions corresponding to the input image, is trained. In the first embodiment, the learning system 10 configured as described above is able to train an image generation model capable of visualizing or depicting, in a plausible manner, appearances of some regions, such as an appearance of a region relatively small with respect to the entire image or an appearance of an anomalous region. The following is a detailed description about the respective functional constituent elements.

The training data acquisition function 131 acquires, from, for example, the storage circuit 120, training data which is configured to include an input image and a correct answer image. Furthermore, for the sake of clarity, the size (the numbers of pixels representing the width and height) of an input image and the size (the numbers of pixels representing the width and height) of a correct answer image are assumed to coincide with each other.

Moreover, the training data acquisition function 131 is an example of a training data acquisition unit. Here, the correct answer image is an image having one or more bright spot regions corresponding to the input image.

The generated image acquisition function 132 outputs a generated image in which a contrast imaging effect has been visualized or depicted based on features visualized or depicted in an input image. Furthermore, for the sake of clarity, the size (the numbers of pixels representing the width and height) of an input image and the size (the numbers of pixels representing the width and height) of a generated image are assumed to coincide with each other. Moreover, the generated image acquisition function 132 is an example of a generated image acquisition unit.

The generated image, which is generated by the image generation model, according to the first embodiment is, specifically, a pseudo-contrast image resembling an FA image in which a contrast imaging effect has been visualized or depicted, such as that to be acquired in FA examination. In more detail, the generated image acquisition function 132 includes an image generation model 1320, which receives, as input data, an OCTA image serving as an input image and outputs a generated image resembling an FA image in which a contrast imaging effect has been visualized or depicted based on anatomical features visualized or depicted in the OCTA image.

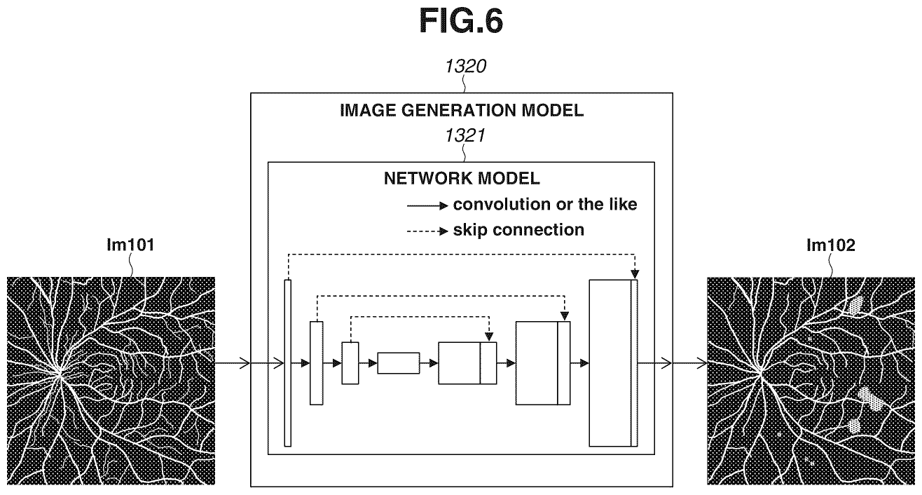

The image generation model is, for example, a model including an image processing system for outputting a generated image with use of rule-based or machine learning (particularly, deep learning techniques). As a specific example, an image generation model including an image processing system using deep learning techniques is described with reference to FIG. 6.

FIG. 6 illustrates an example in which the image generation model 1320 includes a U-Net type network model 1321 as an image processing system using deep learning techniques. Here, U-Net is a known encoder-decoder type network model having a skip connection mechanism.

U-Net, when sufficiently trained with a data set configured with a pair image group including an input image and a corresponding output image, is able to output a plausible image corresponding to an input image according to the tendency of the data set which has been used for learning.

For example, it is known that U-Net is applicable to, for example, image segmentation processing, enhancement of image quality, and image domain conversion according to the data set.

The image generation model 1320 converts an input image Im101 into a tensor and inputs the tensor to the network model 1321, and then causes the tensor which the network model 1321 has output to be output as an output image Im102.

Here, the tensor in the description of the first embodiment is an object in which, for example, a pixel value group in an image is represented as a multidimensional array, and is a data input-output form to a network model, and the image and the tensor are assumed to be able to be exchanged with each other. Moreover, while, in the first embodiment, U-Net is employed as an example, another type of network model capable of attaining a similar objective can be employed.

The bright spot image acquisition function 133 acquires a first bright spot image group, which is a first partial image group of a correct answer image, and a second bright spot image group, which is a second partial image group of a generated image. Furthermore, the bright spot image acquisition function 133 is an example of a bright spot image acquisition unit. Thus, the bright spot image acquisition function 133 is characterized by acquiring a first partial image included in a correct answer image as a first bright spot image and acquiring a second partial image positionally corresponding to the first partial image as a second bright spot image from the generated image.

Specifically, the bright spot image acquisition function 133 refers to each bright spot region group (coordinates of a rectangular region) associated with a correct answer image, included in the data set. Then, the bright spot image acquisition function 133 acquires, as a first bright spot image, a first partial image coincident with the coordinates of the rectangular region in the correct answer image.

Moreover, similarly, with respect to a generated image, the bright spot image acquisition function 133 refers to each bright spot region group (coordinates of a rectangular region) associated with a corresponding correct answer image, and acquires, as a second bright spot image, a second partial image coincident with the coordinates of the rectangular region in the generated image.

Thus, the bright spot image acquisition function 133 acquires, as bright spot image groups, partial image groups having the same coordinates from both a correct answer image and a generated image. Furthermore, while, in the first embodiment, an example in which a plurality of bright spot image groups is acquired from each of a correct answer image and a generated image is described, if the number of pieces of bright spot region information associated with a correct answer image is one, only one bright spot image is acquired.

Moreover, in a case where the coordinates of a rectangular region serving as bright spot region information coincide with the entire coordinate space of an associated correct answer image, the bright spot image acquisition function 133 acquires the entire correct answer image as a bright spot image.

Moreover, a case where the coordinates of a rectangular region serving as bright spot region information are protruding from the entire coordinate space of an associated correct answer image is described. In this case, the bright spot image acquisition function 133 acquires a bright spot image by compensating for the protruded partial region by padding such partial region with use of pixel values of a correct answer image or painting out such partial region with a predetermined value in such a manner that the size of a bright spot image to be obtained coincides with the size of the rectangular region.

Moreover, since a bright spot image group acquired from a correct answer image is not changed during the process of learning processing which the learning system 10 according to the first embodiment performs, the bright spot image acquisition function 133 can acquire, as static data, data preliminarily caused to be included in the data set.

Additionally, the bright spot image acquisition function 133 adjusts pixel values of the acquired bright spot image, and thus, in step S14 described below, can adjust the sensitivity of an error between a bright spot image included in a correct answer image and a bright spot image included in a generated image, which are calculated by the updating function 134.

Specifically, with respect to each bright spot image, the bright spot image acquisition function 133 can perform min-max normalization or vary pixel values by performing addition of a predetermined bias value and performing multiplication of a weight value and then limit (clip) the range of pixel values.

Thus, the bright spot image acquisition function 133 can adjust an error calculated by the updating function 134 in step S14 described below by processing a bright spot image and, as a result, adjust the degree to which to update parameters constituting the network model 1321.

Furthermore, the degree to which to update parameters constituting the network model 1321 in the description of the first embodiment is what is called a loss. The loss is, for example, an average value of value groups indicating errors for output data groups which the network model 1321 has output based on one or more training data groups (mini-batches) selected from the data set. Moreover, the loss can be, for example, a value calculated by performing weighting on value groups indicating errors for the output data groups. Moreover, the loss can be, for example, a value calculated by further performing weighting on the loss.

The updating function 134 updates parameters constituting the network model 1321 and thus changes the performance of the image generation model 1320. Specifically, the updating function 134 updates (optimizes) parameters constituting the network model 1321 included in the image generation model 1320 in such a manner that the above-mentioned loss becomes small. Furthermore, the updating function 134 is an example of an updating unit.

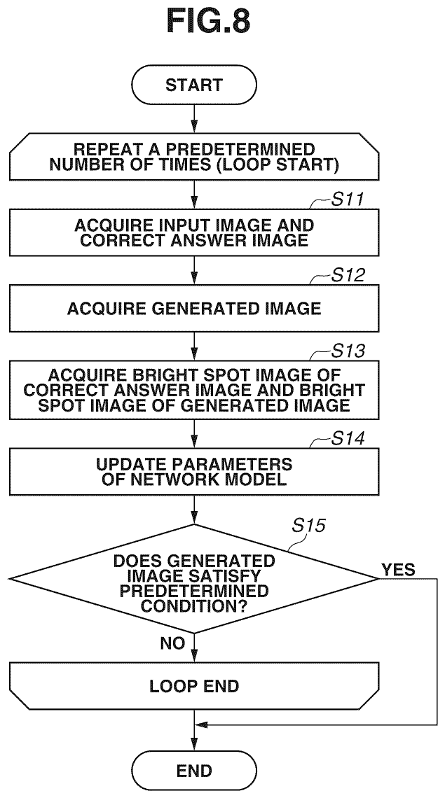

A learning process which the learning system 10 according to the first embodiment performs is described with reference to the flowchart of FIG. 8. FIG. 8 is a flowchart illustrating an example of learning processing for the image generation model 1320 which the learning system 10 according to the first embodiment performs.

Furthermore, for the sake of clarity, a procedure for performing learning processing by updating parameters constituting the network model 1321 with a pair of pieces of training data (thus, a situation in which the mini-batch size is “1”) is described. However, in actual learning processing which the learning system 10 performs, for the purpose of, for example, shortening a completion time of learning processing or stabilizing learning processing, the learning processing can be performed with a plurality of training data groups.

In step S11, the training data acquisition function 131 acquires an input image, which is an OCTA image, and a correct answer image, which is an FA image, which are included in a pair of pieces of training data constituting a data set.

In step S12, the generated image acquisition function 132 inputs the input image acquired in step S11 to the image generation model 1320 and thus acquires a generated image resembling an FA image in which a contrast imaging effect has been visualized or depicted based on features which are visualized or depicted in the input image.

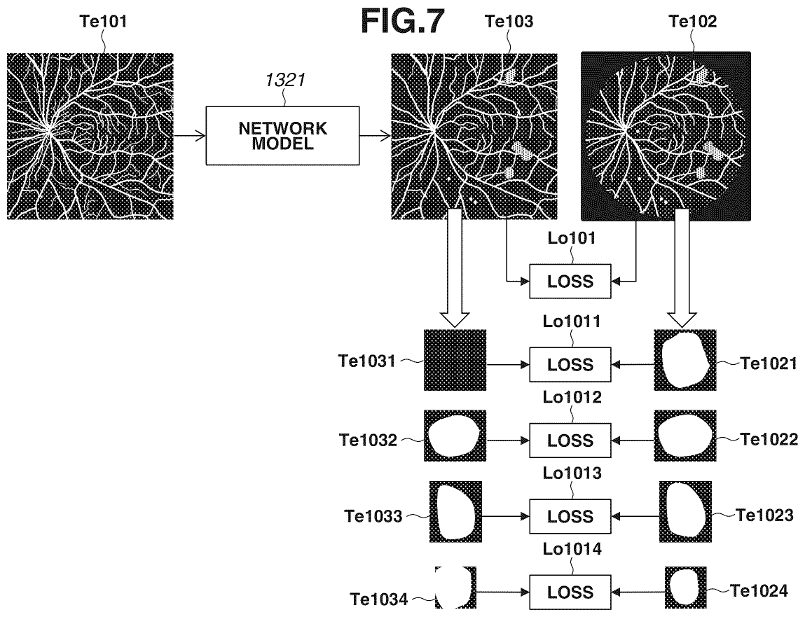

Specifically, as illustrated in FIG. 7, in response to an OCTA image serving as an input image constituting training data being input as an input tensor Te101 to the network model 1321, an output tensor Te103 which is a generated image resembling an FA image is acquired.

In step S13, the bright spot image acquisition function 133 acquires a first bright spot image group of the correct answer image and a second bright spot image group of the generated image.

Specifically, as illustrated in FIG. 7, the bright spot image acquisition function 133 acquires, from a correct answer tensor Te102 serving as a correct answer image, first bright spot images Te1021 to Te1024 by referring to respective pieces of information of a first bright spot region information group associated with the correct answer image. Moreover, the bright spot image acquisition function 133 also acquires, from an output tensor Te103 serving as a generated image resembling an FA image, second bright spot images Te1031 to Te1034 by referring to respective pieces of information of a second bright spot region information group associated with the corresponding correct answer image.

In step S14, the updating function 134 updates parameters constituting the network model 1321 in such a manner that an error between a first bright spot image of the correct answer image and a second bright spot image of the generated image which correspond to each other on the image space decreases.

Regarding the specific description using FIG. 7, first, the updating function 134 acquires a first bright spot image Te1021 acquired from the correct answer tensor Te102 serving as a correct answer image, which is derived from common bright spot region information. Additionally, the updating function 134 acquires a second bright spot image Te1031 acquired from the output tensor Te103 serving as a generated image, and then calculates the value of an error between the first bright spot image Te1021 and the second bright spot image Te1031.

Next, similarly, the updating function 134 calculates each of the values of an error between a first bright spot image Te1022 and a second bright spot image Te1032, an error between a first bright spot image Te1023 and a second bright spot image Te1033, and an error between a first bright spot image Te1024 and a second bright spot image Te1034. The updating function 134 uses the respective calculated values of errors as losses Lo1011 to Lo1014 for updating parameters constituting the network model 1321.

At this time, due to reasons such as preventing the degree to which to update parameters constituting the network model 1321 from being affected by the number of bright spot regions in a correct answer image, the updating function 134 can use the average value of the losses Lo1011 to Lo1014 as a loss.

Furthermore, to calculate the value of an error, the updating function 134 can use a pixel value between pixels which correspond to each other in an image space manner. For example, the updating function 134 can apply indices such as a mean square error, a mean absolute error, or the structural similarity index measure (SSIM), and, for example, can use a function in which, when the value is large, a large value is calculated and, when the value is small, a small value is calculated.

For example, while, in the case of using a mean square error or a mean absolute error, the updating function 134 only needs to use an index value as it is, in the case of using an index in which, when the value is small, a large value is calculated, such as SSIM, the updating function 134 can calculate the value of an error by multiplying the value of SSIM by a negative value.

Moreover, a configuration in which, instead of directly comparing the bright spot images of a correct answer image and a generated image with each other, the updating function 134 compares processed images of the respective bright spot images with each other can be employed. For example, the updating function 134 can be configured to generate processed images obtained by performing, on the respective bright spot images, filter processing for enhancing bright spots and evaluate an error between the generated processed images. This enables defining a loss focusing on the reproduction of a bright spot.

Additionally, it is favorable that the updating function 134 takes into consideration not only an error between bright spot images but also an error between a correct answer image and a generated image and thus performs adjustment in such a manner that the brightness or contrast of a region other than the bright spot region in the generated image or that of the overall generated image resembles that of the correct answer image.

Regarding the specific description using FIG. 7, the updating function 134 also calculates the value of an error between the correct answer tensor Te102 serving as a correct answer image and the output tensor Te103 serving as a generated image.

Then, the updating function 134 uses the calculated value of the error as a loss Lo101 used for updating parameters constituting the network model 1321.

At this time, the updating function 134 can multiply, by a predetermined weighting value, losses that are based on the errors between a bright spot image group of the correct answer image and a bright spot image group of the generated image (the losses Lo1011 to Lo1014 illustrated in FIG. 7) and a loss that is based on an error between the correct answer image and the generated image (the loss Lo101 illustrated in FIG. 7).

Thus, the updating function 134 can adjust, by such multiplication of the weighting value, a degree to which the respective losses affect updating of parameters constituting the network model 1321.

Furthermore, as shown in the correct answer tensor Te102 illustrated in FIG. 7, a mask region (a black region) exists in a region surrounding the FA image serving as a correct answer image. Therefore, in a case where a loss Lo101 obtained by reflecting an error from the output tensor Te103 which is based on such mask region has been used, learning is performed in such a manner that the surrounding region of a generated image which the network model 1321 outputs is also blackly visualized or depicted in a manner similar to the mask region.

To avoid the above-mentioned learning tendency, the updating function 134 can use a loss Lo101 obtained by ignoring an error from the output tensor Te103 which is based on such mask region. Thus, the updating function 134 can calculate the value of an error while targeting a pixel group in a non-mask region of the correct answer image and a pixel group in the generated image corresponding to the non-mask region on an image space, and can use the calculated value as a loss.

In the above-mentioned case, the updating function 134 is able to perform learning in such a way as not to perform visualization or depiction resembling the mask region of the correct answer image in the overall image including a region surrounding the generated image which the network model 1321 outputs. In other words, the updating function 134 is characterized by reducing the influence of a partial error on the error based on the size of the first bright spot region and the size of the background region. Specifically, the updating function 134 is characterized by not calculating an error with respect to a partial region in the first bright spot image based on the size of the first bright spot region and the size of the background region and thus reducing the influence on the error.

In step S15, the learning system 10 determines whether the generated image satisfies a predetermined condition. Specifically, the learning system 10 performs a quality evaluation using training data for verification which is not used in step S11. If it is determined that the image generation model 1320 has been sufficiently trained by the learning system 10, i.e., the quality of the generated image is sufficiently high, the learning system 10 can early stop the learning processing (early stopping).

The learning system 10 repeats the above-mentioned series of processing operations in step S11 to step S15 a predetermined number of times while changing training data in step S11, thus being able to advance the learning processing for the network model 1321.

Furthermore, in the first embodiment, a learning processing system in which the updating function 134 updates parameters constituting the network model 1321 included in the image generation model 1320 based on an error between a first bright spot image group of the correct answer image and a second bright spot image group of the generated image has been described. On the other hand, another learning processing system can be employed.

For example, the updating function 134 can update parameters constituting the network model 1321 by applying a technique concerning a generative adversarial network (GAN) with an image received as an input, such as a conditional GAN serving as a known deep learning technique, and thus can perform learning processing. Thus, the updating function 134 can update parameters constituting the network model 1321 while causing a discriminator network to determine whether a brit spot image group of the generated image which the network model 1321 equivalent to a generator network in the conditional GAN generates is an image such as a real bright spot image (an FA image serving as a correct answer image).

The image generation model 1320, which has been trained by the learning processing which the learning system 10 according to the above-described first embodiment performs, when receiving an OCTA image as an input, becomes able to perform outputting that is based on the tendency of a training data group which has been used for the learning processing. The above-mentioned learning processing enables the image generation model 1320 to output a generated image resembling an FA image in which a region surrounding a small bright spot region, which has been conventionally difficult to visualize or depict, has also been visualized or depicted in a plausible manner.

### Modification Example 1 of First Embodiment

In the above-described first embodiment, a rectangular region corresponding to bright spot region information contains at least one bright spot region, and the coordinates of the rectangular region are adjusted by, for example, the bright spot image acquisition function 133 in such a manner that the area ratio between a bright spot region serving as a foreground and a region other than the bright spot region serving as a background becomes approximately 1:1.

However, in the method described in the first embodiment, depending on the appearance of a bright spot region, it may be difficult to perform adjustment in such a manner that the area ratio becomes approximately 1:1.

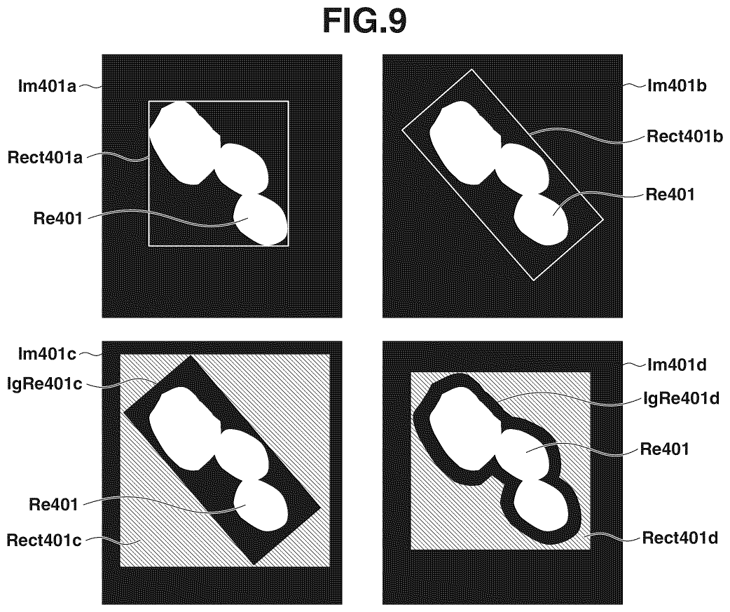

An example of such a situation is specifically described with reference to FIG. 9. A partial image Im401a is a part of a first bright spot region image of an FA image. With respect to the partial image Im401a, an erect (unrotated) minimum rectangle Rect401a containing a bright spot region Re401 is currently set. In the partial image Im401a, it can be understood that a region other than the bright spot region serving as a background is in the state of greatly exceeding the bright spot region serving as a foreground. In this state, even if the coordinates of the rectangular region are adjusted by the method described above in the first embodiment, it is impossible to set the area ratio between the foreground and the background to approximately 1:1.

As a method for coping with such a situation, the bright spot image acquisition function 133 can set a rotated rectangular region Rect401b in a partial image Im401b, thus setting the area ratio between the foreground and the background to approximately 1:1. However, since the rectangular region Rect401b is in the state of having been rotated with respect to an image space coordinate system, as a result, interpolated pixels are contained in an erect bright spot image which the bright spot image acquisition function 133 acquires.

As another method, when calculating the value of an error between a bright spot image of the correct answer image and a bright spot image of the generated image, the bright spot image acquisition function 133 can set an ignored region in which any error is not calculated by the updating function 134. Specifically, the bright spot image acquisition function 133 sets an ignored region IgRe401c (hatched portion) included in a rectangular region Rect401c in a partial image Im401c.

At this time, a background region from which the updating function 134 calculates an error becomes a region (a black region surrounding the bright spot region) obtained by excluding the bright spot region Re401 serving as a foreground and the ignored region IgRe401c from the rectangular region Rect401c. Here, the outline outside the background region coincides with the rotated rectangular region Rect401b, so that the area ratio between the foreground and the background becomes approximately 1:1.

Moreover, as another mode for similarly setting, by the bright spot image acquisition function 133, an ignored region from which any error is not calculated, there is a method of setting an ignored region IgRe401d (hatched portion) inside a rectangular region Rect401d in a partial image Im401d. In this case, a background region from which the updating function 134 calculates an error is a free region containing the bright spot region Re401. Even in this case, the bright spot image acquisition function 133 performs adjustment by expanding the background region in such a manner that the area ratio between the foreground and the background becomes approximately 1:1. Examples of the expansion method performed by the bright spot image acquisition function 133 include a method of adjusting, as a margin, the distance from the outline of the bright spot region Re401 to the outer outline of the background region.

In the method of setting an ignored region from which any error is not calculated, the bright spot image acquisition function 133 causes the bright spot region information to include not only information concerning the coordinates of a rectangular region containing a bright spot region but also coordinate information about a pixel group serving as an ignored region (or a segment image from which equivalent information is acquirable). Additionally, in step S14 according to the first embodiment, the updating function 134 refers to the coordinate information about a pixel group serving as an ignored region included in the bright spot region information, and thus does not calculate an error in the ignored region.

Alternatively, the updating function 134 does not reflect an error corresponding to the ignored region in a loss.

Furthermore, as mentioned above, in a case where a region other than the leakage region in a correct answer image is set as a background by the bright spot image acquisition function 133, in some cases, the background includes a region having a high pixel value similar to that of a bright spot region such as a blood vessel region. In such cases, it is favorable that the bright spot image acquisition function 133 preliminarily sets such region having characteristics similar to a mode in which the visualizing or depicting performance is intended to be improved as an ignored region from which any error is not calculated and then performs the above-described procedure.

The above-described processing enables advancing learning processing in a state in which the area ratio between a bright spot region serving as a foreground and a region other than the bright spot region serving as a background is approximately 1:1.

### Modification Example 2 of First Embodiment

While, in the above-described first embodiment, a configuration in which one bright spot region is included in one partial image has been described, a configuration in which a plurality of bright spot regions is included in one partial image can be employed. Additionally, a configuration in which the bright spot image acquisition function 133 sets only one partial image in which all of the bright spot regions are included with respect to each input image can be employed, or a configuration in which, without creating a partial image, the bright spot image acquisition function 133 treats the entire range of an input image in the same manner as that in the above-mentioned partial image can be employed.

In this case, it is desirable that, as with the modification example 1, the bright spot image acquisition function 133 sets an ignored region from which any error is not calculated, in such a manner that the area ratio between a foreground and a background becomes approximately 1:1. This also enables advancing learning processing in a state in which the area ratio between a bright spot region serving as a foreground and a region other than the bright spot region serving as a background is approximately 1:1.

### Modification Example 3 of First Embodiment

In the above-described first embodiment, a configuration in which the bright spot image acquisition function 133 performs setting in such a manner that the area ratio between a foreground and a background becomes approximately 1:1 with respect to each of partial images has been described. However, the bright spot image acquisition function 133 only needs to perform setting in such a manner that the area ratio between a foreground and a background becomes approximately 1:1 with respect to the totality of partial images. For example, a configuration in which the bright spot image acquisition function 133 does not perform setting in such a manner that the area ratio between a foreground and a background becomes approximately 1:1 with respect to each of partial images can be employed.

In another configuration which can be employed, first, the bright spot image acquisition function 133 calculates the sum Si of areas of all of the bright spot regions with respect to each input image. Next, the bright spot image acquisition function 133 obtains an appropriate value of the sum of areas of partial images as a constant multiplication (normally, 2 times) of the sum Si of areas. Additionally, the bright spot image acquisition function 133 sets a value Sm obtained by dividing the sum of areas of partial images by the number M of partial images (Sm=2×Si/M) as an area common to the respective partial images.

Moreover, a configuration in which, only in a case where a bright spot region does not fit into the thus-obtained partial image, the bright spot image acquisition function 133 enlarges the size of the partial image in such a manner that the bright spot region fits into the partial image can be employed. This also enables advancing learning processing in a state in which the area ratio between a bright spot region serving as a foreground and a region other than the bright spot region serving as a background is approximately 1:1.

### Modification Example 4 of First Embodiment

In the above-described first embodiment, a configuration in which the bright spot image acquisition function 133 dynamically sets the size of a partial image based on each input image to be used for learning, thus causing the area ratio between a foreground and a background to become approximately 1:1, has been described. However, the area ratio between a foreground and a background only needs to be set to approximately 1:1, and a configuration in which the bright spot image acquisition function 133 does not determine the size of a partial image based on each input image can be employed.

For example, the bright spot image acquisition function 133 can preliminarily set the size of a partial image to a predetermined value by which the area thereof is caused to become a constant multiple thereof (normally, 2 times), based on the normal size of a bright spot region.

Here, the size of a partial image can be a fixed value, or a configuration in which, only in a case where a bright spot region does not fit into the thus-obtained partial image, the bright spot image acquisition function 133 enlarges the size of the partial image in such a manner that the bright spot region fits into the partial image can be employed. This also enables advancing learning processing in a state in which the area ratio between a bright spot region serving as a foreground and a region other than the bright spot region serving as a background is approximately 1:1.

### Second Embodiment

In a second embodiment, instead of omitting the adjustment of the coordinates of a rectangular region serving as bright spot region information in the first embodiment (the adjustment for causing the area ratio between a foreground and a background to become approximately 1:1), a learning system 100 performs learning processing for adjusting a loss. Furthermore, performing both methods described in the first embodiment and the second embodiment in combination is not excluded.

While, in the following description, the second embodiment is described, constituent elements similar to those in the first embodiment are omitted from description here.

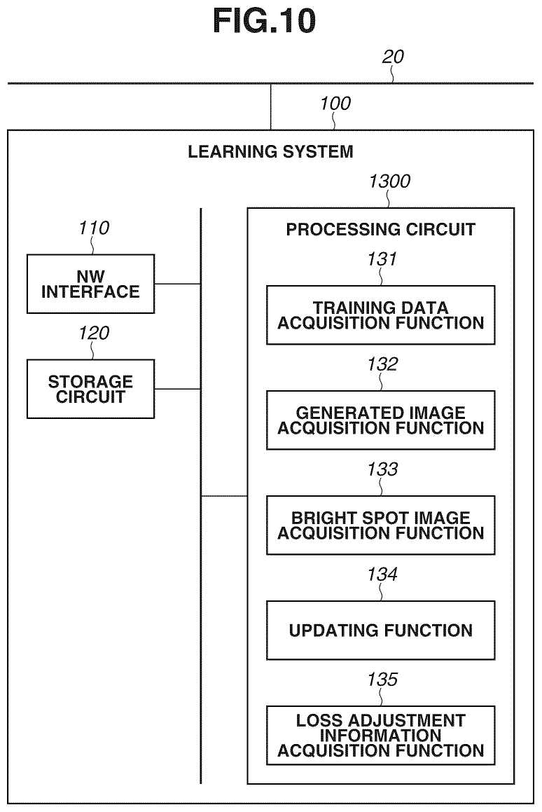

First, an example of a configuration of the learning system 100 according to the second embodiment is described with reference to FIG. 10.

A processing circuit 1300 in the second embodiment includes, in addition to the constituent elements of the processing circuit 130 in the first embodiment, a loss adjustment information acquisition function 135. Moreover, the updating function 134 adjusts a degree to which to update the image generation model 1320, based on loss adjustment information.

The loss adjustment information acquisition function 135 acquires loss adjustment information, which is used to adjust the value of a loss for updating parameters constituting the network model 1321, based on information concerning a luminance distribution of a first bright spot image. Here, the loss adjustment information is, specifically, a scalar value for weighting each loss. The scalar value is, for example, a value which becomes larger as the area ratio between a foreground and a background in a given bright spot image is more away from 1:1, i.e., as the balance between the area of a foreground (bright spot region) and the area of a background (for example, a region other than the bright spot region or a region other than the bright spot region and a blood vessel region) is poorer (the proportion of the foreground is lower). Furthermore, the loss adjustment information acquisition function 135 is an example of a loss adjustment information acquisition unit.

As with the first embodiment, a data set according to the second embodiment includes, in the form associated with each FA image included in the data set, bright spot region information, which is information concerning the coordinates of a rectangular region containing each bright spot region of a bright spot region group of the FA image.

However, a rectangular region corresponding to the bright spot region information (coordinates of the rectangular region) does not need to be coordinates for causing the area ratio (in the case of targeting a three-dimensional image, the volume ratio) between a foreground and a background to become approximately 1:1 when a bright spot region is set as the foreground and a region other than the bright spot region is set as the background as in the first embodiment.

For example, the rectangular region can be set as a rectangle with a preliminarily set size. The size of the rectangle is optional, but can be determined based on, for example, the normal size of a bright spot.

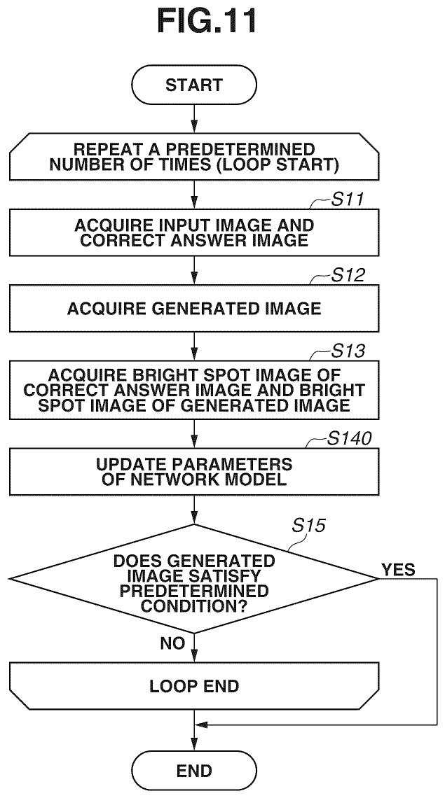

Next, learning processing which the learning system 100 according to the second embodiment performs is described with reference to FIG. 11.

Step S11 to step S13 are similar to those in the first embodiment and are, therefore, omitted from description here.

In step S140, as with the first embodiment, the updating function 134 acquires losses Lo1011 to Lo1014, which are used for updating parameters constituting the network model 1321, and a loss Lo101. Here, in the second embodiment, additionally, the loss adjustment information acquisition function 135 acquires pieces of loss adjustment information corresponding to the respective losses. The updating function 134 adjusts the losses Lo1011 to Lo1014 by the acquired pieces of loss adjustment information, and then updates parameters constituting the network model 1321.

Furthermore, to acquire a scalar value which is loss adjustment information corresponding to a given loss, the loss adjustment information acquisition function 135 refers to a first bright spot image of a correct answer image which has been used for calculation of the value of an error from which the given loss is derived. The loss adjustment information acquisition function 135 acquires information concerning adjustment of a loss based on at least one of the size of a bright spot region and the size of a background region in the first bright spot image. Here, the information concerning a luminance distribution is a statistical value of luminance values of a pixel group constituting the first bright spot image.

For example, the loss adjustment information acquisition function 135 is able to acquire a scalar value α serving as loss adjustment information by the following formula (1) using the area A of a bright spot image of a correct answer image and the area “b” of a bright spot region in the bright spot image (a foreground in the second embodiment). Furthermore, in a case where the scalar value α exceeds a predetermined value, the loss adjustment information acquisition function 135 can limit the maximum value of the scalar value α to the predetermined value.

$$α = \frac{1}{1 - \vert 1 - \frac{2 b}{A} \vert} \qquad ( 1 )$$

Moreover, as an example of another acquisition method, the loss adjustment information acquisition function 135 can acquire the scalar value α with use of the area A of a bright spot image of a correct answer image and the area “d” of a region other than a bright spot region in the bright spot image (a background in the second embodiment). Specifically, the loss adjustment information acquisition function 135 can acquire the scalar value α by the following formula (2). Furthermore, as with formula (1), in a case where the scalar value α exceeds a predetermined value, the loss adjustment information acquisition function 135 can limit the maximum value of the scalar value α to the predetermined value.

$$α = \frac{1}{1 - \vert \frac{2 d}{A} - 1 \vert} \qquad ( 2 )$$

Moreover, the loss adjustment information acquisition function 135 can use, in addition to the above-mentioned formulae, such another calculation formula that, as the proportion of a foreground is lower, a larger scalar value α is set.

Furthermore, as mentioned above, in a case where a region other than the leakage region in a correct answer image is set as a background, in some cases, the background includes a region having a high pixel value similar to that of a bright spot region such as a blood vessel region. In such cases, it is favorable that the loss adjustment information acquisition function 135 calculating the scalar value α is prevented from being affected by such region having characteristics similar to a mode in which the visualizing or depicting performance is intended to be improved. Specifically, the loss adjustment information acquisition function 135 can also be configured to subtract the area of such region from the area A of a bright spot image and the area “d” of a region other than a bright spot region and then calculate the scalar value α by formula (2).

Moreover, the loss adjustment information acquisition function 135 is able to acquire a new loss (i.e., a loss subjected to adjustment) L′ by the following formula (3) using a loss L serving as an adjustment target and a scalar value α serving as loss adjustment information.

$${L}^{′} = α L \qquad ( 3 )$$

Step S15 is similar to that in the first embodiment.

The learning system 100 repeats the above-mentioned series of processing operations in step S11 to step S15 a predetermined number of times while changing training data in step S11, thus being able to advance the learning processing for the network model 1321.

Furthermore, the loss adjustment information acquisition function 135 can be configured to calculate the scalar value α individually with respect to each partial image. Moreover, the loss adjustment information acquisition function 135 can be configured to calculate a scalar value α in common to partial images with use of the sum of areas of all of the partial images and the sum of areas of foregrounds with respect to each input image.

Even any configuration enables advancing learning processing focusing on the reproduction of a bright spot region.

The image generation model 1320, which has been trained by the learning processing which the learning system 100 according to the above-described second embodiment performs, when receiving an OCTA image as an input, becomes able to perform outputting that is based on the tendency of a training data group which has been used for the learning processing. The above-mentioned learning processing enables the image generation model 1320 to output a generated image resembling an FA image in which a region surrounding a small bright spot region, which has been conventionally difficult to visualize or depict, has also been visualized or depicted in a plausible manner.

### Modification Example 1 of Second Embodiment

In the above-described second embodiment, an example in which the loss adjustment information acquisition function 135 calculates a scalar value α serving as loss adjustment information from area information concerning a bright spot image of a correct answer image has been described. In a modification example 1 of the second embodiment, the loss adjustment information acquisition function 135 attains an approximately similar objective with use of statistical information about pixel values concerning a bright spot image of a correct answer image.

There is a method in which, for example, as the average pixel value of a given bright spot image moves more away from an average pixel value which is expected in a case where the area ratio between a foreground and a background is 1:1, the loss adjustment information acquisition function 135 sets the scalar value α larger. As a specific example, the loss adjustment information acquisition function 135 is able to acquire a scalar value α serving as loss adjustment information by the following formula (4) using a minimum value Vₘᵢₙ and a maximum value Vₘₐₓ which are determined from a value range of pixel values of a correct answer image group and an average pixel value of a bright spot image of a correct answer image. Furthermore, in formula (4), the average pixel value which is expected in a case where the area ratio between a foreground and a background is 1:1 is assumed to be an intermediate value between the minimum value Vₘᵢₙ and the maximum value Vₘₐₓ, i.e., “(Vₘᵢₙ+Vₘₐₓ)/2”. Moreover, as with the second embodiment, in a case where the scalar value α exceeds a predetermined value, the loss adjustment information acquisition function 135 can limit the maximum value of the scalar value α to the predetermined value.

$$α = \frac{1}{1 - \vert 1 - \frac{2 ( μ - {V}_{min} )}{{V}_{max} - {V}_{min}} \vert} \qquad ( 4 )$$

Furthermore, as mentioned above, in a case where a region other than the leakage region in a correct answer image is set as a background, in some cases, the background includes a region having a high pixel value similar to that of a bright spot region such as a blood vessel region. In such cases, it is favorable that the loss adjustment information acquisition function 135 calculating the scalar value α is prevented from being affected by such region having characteristics similar to a mode in which the visualizing or depicting performance is intended to be improved. Specifically, the loss adjustment information acquisition function 135 can be configured to, when calculating the average pixel value μ, avoid considering the pixel values of such region and then calculate the scalar value α by formula (4).

### Modification Example 2 of Second Embodiment

While, in the above-described second embodiment, a configuration in which one bright spot region is included in one partial image has been described, a configuration in which, as with the modification example 2 of the first embodiment, the bright spot image acquisition function 133 treats each input image in which a plurality of bright spot regions is included in one partial image can be employed.

### Modification Example 3 of Second Embodiment

While, in the above-described second embodiment, a configuration in which the loss adjustment information acquisition function 135 dynamically sets the scalar value α based on an input image which is used for learning has been described, a configuration in which the loss adjustment information acquisition function 135 uses a fixed value as the scalar value α can be employed. For example, the loss adjustment information acquisition function 135 can obtain the area ratio between a partial image and a bright spot region based on the standard size of a bright spot region and set a fixed value corresponding to the obtained area ratio as the scalar value α. This also enables advancing learning processing focusing on the reproduction of a bright spot region.

### Third Embodiment

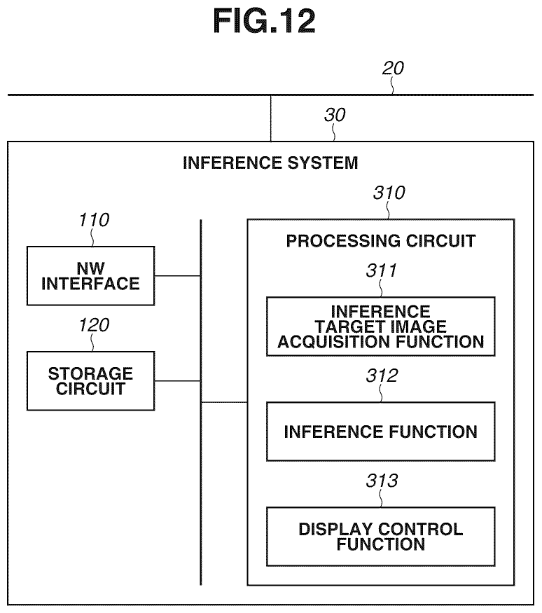

A third embodiment is described with reference to FIG. 12. In the third embodiment, the storage circuit 120 stores an image generation model which has been trained by at least one of the learning systems 10 and 100 in the first embodiment and the second embodiment. Furthermore, an inference system 30 can be configured as the same system as the learning system 10 by the same entity as the learning system 10, or can be a system in which an image generation model trained by another entity has been acquired via, for example, the network 20.

Furthermore, a system which is configured with a different device configured by the same entity is also included in an expected range of the third embodiment.

The inference system 30 includes an inference target image acquisition function 311, which acquires an inference target image from, for example, the storage circuit 120. Additionally, the inference system 30 is an inference system which uses a trained image generation model which has been trained by the learning method described in the first embodiment or the second embodiment. The inference system 30 is configured to further include an inference function 312, which performs inference processing on an inference target image with use of the trained image generation model, and a display control function 313, which causes, for example, a display unit to display an inference result. The trained image generation model is generated by being trained with use of training data which is configured with an input image and a correct answer image having one or more bright spot regions corresponding to the input image. Specifically, the trained image generation model is a model which has been trained based on an error between a first bright spot image that is based on a correct answer image and a second bright spot image that is based on a generated image output from the image generation model in response to an input image being input thereto.

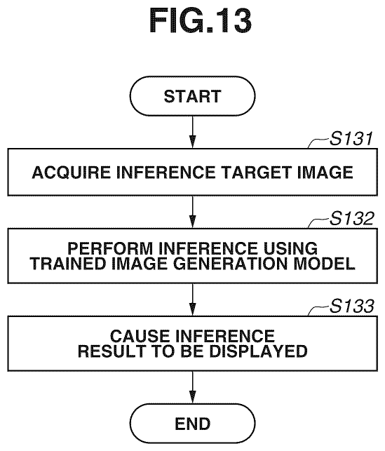

An inference process which the inference system 30 according to the third embodiment performs is described with reference to FIG. 13.

In step S131, the inference target image acquisition function 311 acquires an inference target image from, for example, the storage circuit 120, and then advances the processing to step S132.

In step S132, the inference function 312 acquires an image generation model trained based on an error between a first bright spot image that is based on a correct answer image and a second bright spot image that is based on a generated image output from the image generation model in response to an input image being input thereto. The inference function 312 applies the trained image generation model to the inference target image, thus performing inference processing, and then advances the processing to step S133.

In step S133, the display control function 313 causes, for example, a display unit to display an inference result acquired by executing the inference function 312, and then ends the inference process.

In the third embodiment, a trained image generation model acquired via the above-described learning process is able to be used for the inference process. Therefore, a high-accuracy inference result in which appearances of some regions, such as an appearance of a region relatively small with respect to the entire image or an appearance of an anomalous region, have been visualized or depicted in a plausible manner can be acquired.

### Other Embodiment

A generated image can be generated from an OCTA image by the learning system 10 or 100 equipped with an image generation model having a network model in which the learning process has been completed by any one of the above-described embodiments and modification examples thereof or another apparatus. Moreover, the generated image generated from the OCTA image can be displayed on a display device. Moreover, the generated image can be stored in, for example, a storage device. Alternatively, after the generated image is further processed, the processed generated image can be displayed on a display device or can be stored in, for example, a storage device.

Moreover, while, in the above description of embodiments and modification examples, a bright spot region is set as a target, the “range” in a condition of “a connected region with an area or volume within a predetermined range thereof” for identifying a bright spot region can be changed. The visualizing or depicting performance with respect to all of the leakage regions can be improved by such a configuration. Alternatively, the visualizing or depicting performance for only the above-mentioned large leakage region can be improved.

While some embodiments have been described above, these embodiments are presented as examples and are not intended to limit the scope of every embodiment. These embodiments can be implemented in various other forms, and, within a scope not departing from the gist of the disclosure, various omissions, substitutions, alterations, and combinations of embodiments can be made. These embodiments and modifications thereof are included within the scope and gist of the disclosure as well as within the scope of the embodiments set forth in the claims and equivalents thereof.

According to an aspect of the present disclosure, an image generation model capable of visualizing or depicting appearances of some regions, such as an appearance of a region relatively small with respect to the entire image or an appearance of an anomalous region, can be acquired.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-124475, which was filed on Jul. 31, 2024 and which is hereby incorporated by reference herein in its entirety.

What is claimed is:

1. A learning system for performing training of an image generation model configured to output a generated image having one or more bright spot regions and corresponding to an input image, the learning system comprising:
at least one processor; and
at least one memory that is in communication with the at least one processor, wherein the at least one memory stores instructions for causing the at least one processor and the at least one memory to:
acquire training data including an input image and a correct answer image having one or more bright spot regions, wherein the correct answer image corresponds to the input image;
input the input image to the image generation model and acquire a generated image;
acquire, based on the correct answer image, a first bright spot image including at least one bright spot region included in the one or more bright spot regions;
acquire, based on the generated image obtained by inputting the input image to the image generation model, a second bright spot image corresponding to the first bright spot image; and
update the image generation model based on an error between the first bright spot image and the second bright spot image.

2. The learning system according to claim 1, wherein the at least one memory further stores instructions for causing the at least one processor and the at least one memory to determine sizes of the first bright spot image and the second bright spot image based on a relationship between a size of a bright spot region visualized or depicted in the first bright spot image and a size of a background region that is at least a partial region other than the bright spot region in the first bright spot image.

3. The learning system according to claim 1, wherein the at least one memory further stores instructions for causing the at least one processor and the at least one memory to reduce an influence, on the error, of an error in a partial region based on a size of a bright spot region and a size of a background region in the first bright spot image.

4. The learning system according to claim 3, wherein the at least one memory further stores instructions for causing the at least one processor and the at least one memory to reduce an influence on the error by not calculating an error with respect to the partial region in the first bright spot image based on the size of the bright spot region and the size of the background region.

5. The learning system according to claim 1, wherein the at least one memory further stores instructions for causing the at least one processor and the at least one memory to:
acquire loss adjustment information concerning adjustment of a loss based on information concerning a luminance distribution of the first bright spot image; and
adjust a degree to which to update the image generation model based on the loss adjustment information.

6. The learning system according to claim 5, wherein the at least one memory further stores instructions for causing the at least one processor and the at least one memory to acquire the loss adjustment information based on at least one of a size of a bright spot region and a size of a background region in the first bright spot image.

7. The learning system according to claim 5, wherein the information concerning the luminance distribution is a statistical value of luminance values of a pixel group constituting the first bright spot image.

8. The learning system according to claim 1, wherein the at least one memory further stores instructions for causing the at least one processor and the at least one memory to update the image generation model further based on an error between the correct answer image and the generated image.

9. The learning system according to claim 1, wherein the at least one memory further stores instructions for causing the at least one processor and the at least one memory to acquire, as the first bright spot image, a first partial image included in the correct answer image and acquire, as the second bright spot image, a second partial image positionally corresponding to the first partial image from the generated image.

10. The learning system according to claim 1, wherein the at least one memory further stores instructions for causing the at least one processor and the at least one memory to acquire, as the bright spot region, at least a partial region of a connected region having a pixel value greater than or equal to a predetermined value or a pixel value less than or equal to a predetermined value in an image and having a size within a predetermined range.

11. The learning system according to claim 1, wherein the bright spot region is derived from a capillary aneurysm in a subject in the correct answer image.

12. The learning system according to claim 11, wherein the at least one memory further stores instructions for causing the at least one processor and the at least one memory to acquire, as the bright spot region, a region smaller than a predetermined value included in a leakage region image derived from the capillary aneurysm.

13. The learning system according to claim 1, wherein the at least one memory further stores instructions for causing the at least one processor and the at least one memory to adjust pixel values of the first bright spot image and the second bright spot image and thus adjust the error.

14. An inference system comprising:
at least one processor; and
at least one memory that is in communication with the at least one processor, wherein the at least one memory stores instructions for causing the at least one processor and the at least one memory to:
acquire an inference target image;
perform inference processing using the image generation model trained by the learning system according to claim 1; and
cause a result of the inference processing to be displayed.

15. An inference system comprising:
at least one processor; and
at least one memory that is in communication with the at least one processor, wherein the at least one memory stores instructions for causing the at least one processor and the at least one memory to:
acquire an inference target image;
perform inference on the inference target image with use of an image generation model trained with use of training data including an input image and a correct answer image having one or more bright spot regions, the correct answer image corresponding to the input image, and trained based on an error between a first bright spot image that is based on the correct answer image and a second bright spot image that is based on a generated image output from the image generation model in response to the input image being input thereto; and
cause a display to display a result of the inference.

16. A learning method for performing training of an image generation model configured to output a generated image having one or more bright spot regions and corresponding to an input image, the learning method comprising:
acquiring training data including an input image and a correct answer image having one or more bright spot regions, wherein the correct answer image corresponds to the input image;
inputting the input image to the image generation model and acquiring a generated image;
acquiring, based on the correct answer image, a first bright spot image including at least one bright spot region included in the one or more bright spot regions;
acquiring, based on the generated image obtained by inputting the input image to the image generation model, a second bright spot image corresponding to the first bright spot image; and
updating the image generation model based on an error between the first bright spot image and the second bright spot image.

17. An inference method comprising:
acquiring an inference target image;
performing inference on the inference target image with use of an image generation model trained with use of training data including an input image and a correct answer image having one or more bright spot regions, the correct answer image corresponding to the input image, and trained based on an error between a first bright spot image that is based on the correct answer image and a second bright spot image that is based on a generated image output from the image generation model in response to the input image being input thereto; and
causing a display to display a result of the inference.

18. A non-transitory computer-readable storage medium storing computer-executable instructions that, when executed by a computer, cause the computer to perform a learning method for performing training of an image generation model configured to output a generated image having one or more bright spot regions, which corresponds to an input image, the learning method comprising:
acquiring training data including an input image and a correct answer image having one or more bright spot regions, wherein the correct answer image corresponds to the input image;
inputting the input image to the image generation model and acquiring a generated image;
acquiring, based on the correct answer image, a first bright spot image including at least one bright spot region included in the one or more bright spot regions;
acquiring, based on the generated image obtained by inputting the input image to the image generation model, a second bright spot image corresponding to the first bright spot image; and
updating the image generation model based on an error between the first bright spot image and the second bright spot image.

19. A non-transitory computer-readable storage medium storing computer-executable instructions that, when executed by a computer, cause the computer to perform an inference method comprising:
acquiring an inference target image;
performing inference on the inference target image with use of an image generation model trained with use of training data including an input image and a correct answer image having one or more bright spot regions, the correct answer image corresponding to the input image, and trained based on an error between a first bright spot image that is based on the correct answer image and a second bright spot image that is based on a generated image output from the image generation model in response to the input image being input thereto; and
causing a display to display a result of the inference.
